(19) United States
(12) Patent Application Publication
(10) Pub. No.: US 2024/0179612 A1
(43) Pub. Date: May 30, 2024

(54) METHOD FOR CONTROLLING A MULTI-HOP TRANSMISSION IN A WIRELESS COMMUNICATION NETWORK, METHOD FOR PROCESSING A MULTI-HOP TRANSMISSION, CORRESPONDING DEVICES, RELAY NODE, COMMUNICATION NODE, SOURCE NODE, SYSTEM AND COMPUTER PROGRAMS

(71) Applicant: ORANGE, Issy-les-Moulineaux (FR)

(72) Inventor: Jean-Marc Kelif, CHÂTILLON CEDEX (FR)

(21) Appl. No.: 18/551,724

(22) PCT Filed: Mar. 25, 2022
(86) PCT No.: PCT/FR2022/050556

§ 371 Date: Sep. 21, 2023

(30) Foreign Application Priority Data
Mar. 26, 2021 (FR) 2103136

(51) Int. Cl. H04W 40/22; H04W 28/22; H04W 84/04

(52) U.S. Cl. CPC H04W 40/22; H04W 28/22; H04W 84/047

(57) ABSTRACT

A method for controlling a multi-hop transmission in a wireless communication network. The method includes: obtaining for a current relay node of a plurality, located at i hops, i being a non-null integer, a current strength ratio between a strength of a radio signal and a noise and interference strength, at the current relay node, received by the current relay node; estimating an overall transmission rate between a source node and a destination node located at a number of hops N, N being an integer greater than or equal to i, at least from the current strength ratio, strength measurement ratios previously obtained for relay nodes located between the source node and the current relay node, and a transmission bandwidth; adjusting a data transmission parameter of at least the source node and/or a relay node participating in the transmission, when the estimated overall transmission rate differs from a target rate.

### CROSS-REFERENCE TO RELATED APPLICATIONS

This Application is a Section 371 National Stage Application of International Application No. PCT/FR2022/050556, filed Mar. 25, 2022, which is incorporated herein by reference in its entirety and published as WO 2022/200745 A1 on Sep. 29, 2022, not in English.

### TECHNICAL FIELD OF THE DISCLOSURE

The field of the disclosure is that of a wireless communication network, for example of the cellular type, comprising a plurality of relay nodes configured to receive a radio signal carrying a useful data volume transmitted by a source node in said network, amplify it and relay it in whole or in part, or even complete it.

In particular, the disclosure relates to controlling an overall transmission rate of such a radio signal in said network from the source node to a destination node.

### PRIOR ART

A wireless communication network, for example of the cellular radio type, is known in which a source node, for example a mobile terminal, for example in a vehicle, transmits a radio signal and this signal is relayed by several “Amplify and Forward” relay nodes before reaching its destination. This is also known as multi-hop transmission, where each hop refers to the reception, amplification and retransmission of the radio signal by a relay node. It should be noted that the destination of the radio signal transmitted by the source node is not necessarily known to the source node in advance. The radio signal may indeed be transmitted to a particular node, but it may also be transmitted to one or more nodes, for example nodes verifying a predetermined condition such as being located within a number of hops from the source node that is less than or equal to a given number, or within a given geographical radius. Such a relay node is configured to amplify the total strength of the received signal before retransmitting it to a following relay node. The strength received by the destination node from the last relay node is thus made up of the one of the useful signal transmitted by the source node and a non-useful strength due to the interference undergone by the signal at each hop and the undifferentiated amplification of the interference and the useful signal performed by each relay node. This interference comes from all the nodes of the network transmitting at the same frequency as the transmitted signal. One use case for multi-hop transmissions involves motorised vehicles, such as cars, travelling in a line on a road. The first car transmits information carried by a radio signal to the one following it. It is for example information relating to the control of the vehicle, such as information relating to a braking or change of steering command. The second car uses, if appropriate, the command embedded in the radio signal it has received, re-amplifies it and retransmits it to the next car in line, and so on. In this case, the maximum number of possible cars likely to receive and retransmit the signal is not necessarily known a priori.

One disadvantage of this amplification and direct retransmission communication mode is that the signal can be re-amplified and relayed multiple times to its destination. These successive re-amplifications also induce an amplification of interference. In this context, it is complex to predict and quantify system performance and in particular to guarantee a target quality of service level such as a target transmission rate for the multi-hop transmission implemented between the source node and the destination node.

### SUMMARY

An exemplary aspect of the disclosure responds to this need by proposing a method for controlling a multi-hop transmission in a wireless communication network, said transmission implementing a plurality of relay nodes of said wireless communication network, a relay node, referred to as the current relay node of said plurality, located at i hops, with i a non-null integer, being configured to receive from a source node or from a previous relay node located at hop i-1, a radio signal carrying a data volume transmitted by said source node, to amplify it and to retransmit it to a next relay node, placed at i+1 hops.

Said method comprises:
obtaining for said current relay node a current strength ratio between a strength of the radio signal and a noise and interference strength, at said current relay node, received and measured by said current relay node;
estimating an overall transmission rate between the source node and a destination node located at a number of hops N, with N an integer greater than or equal to i, at least from the current strength ratio, from strength measurement ratios previously obtained for relay nodes located between the source node and said current relay node and from a transmission bandwidth; and
adjusting at least one data transmission parameter of at least the source node and/or one said relay node participating in the multi-hop transmission, when the estimated overall transmission rate differs from a target rate.

An aspect of the disclosure makes it possible to control the transmission rate of a data volume by adjusting at least one data transmission parameter between the source node and the destination node located at N hops from the source node. In this way, a target data transmission rate required at the destination node can be guaranteed for the current data volume or for another subsequent data volume transmitted within the same multi-hop transmission.

This adjustment is applied to at least one communication node participating in the multi-hop transmission, such as the source node and/or at least one of the relay nodes. When the adjustment relates to the source node, one advantage is that modifying a transmission parameter at the source node alone has an impact on the entire data volume relay chain. In this case, it will apply to the transmission of a next data volume.

When the adjustment relates to a relay node, it has an impact on the transmission of the data volume in progress as soon as it relates to the current relay node or a next relay node that has not yet retransmitted the radio signal from the source node.

At the current relay node (i.e. at the current hop i) for which the last strength measurement ratio was received, the modification will have an impact on the part of the data volume currently being transmitted that has not yet been transmitted.

The adjusted transmission parameter can advantageously be transmitted to it or them in an action message. When the control method is implemented by the relay node itself, it can update its configuration directly.

The adjusted transmission parameter can advantageously be transmitted to the relevant node(s) in an action message.

The control method according to an aspect of the disclosure can be implemented by the source node itself, one of the relay nodes or any other communication node of the wireless communication network. If it is the source node, it can update its configuration directly.

For example, said at least one transmission parameter comprises a transmission strength of the radio signal by the source node or a relay node of said plurality and/or a bandwidth value at the source node or a relay node of said plurality.

Advantageously, the adjustment comprises an increase in at least one said data transmission parameter, if the estimated overall transmission rate is less than the target transmission rate, and a decrease otherwise.

In this case, the action message can comprise a field indicating a value for the increment or decrement. Alternatively, a predetermined increment or decrement value is known a priori to each of the communication nodes, source node and relay node involved and transmission is necessary only if the modification to be applied is an increment or a decrement.

According to one aspect of the disclosure, when the number of hops N at which the destination node is located is greater than i, the method comprises a prediction of the strength ratios of the relay nodes located between i+1 and N hops and the estimation of the overall transmission rate to the destination node takes into account the predicted strength ratios.

When the adjustment applies to at least one transmission parameter of at least one next relay node located between i+1 and N hops, since no strength measurement has been received yet, their strength ratio can be predicted, for example, from those already obtained from the previous relays. The advantage of having them modify one or more communication parameters in advance is that this modification will apply to the entire data volume. The impact of the adjustment will therefore be much greater.

According to yet another aspect of the disclosure, the overall transmission rate is estimated from the following expression:

$$D {G}_{N} = W \cdot \frac{1}{{\sum }_{i = 1}^{N} \frac{1}{{log}_{2} ( 1 + \frac{1}{{\prod }_{j = 1}^{i} ( 1 + \frac{1}{{θ}_{j}} )}}}$$

where W designates a transmission bandwidth between the source node and the destination node; and θⱼ is the strength ratio of a relay node ERj preceding the current relay node ERi.

In this embodiment, the bandwidth is assumed to be constant throughout the transmission. One advantage is that it is relatively easy to estimate a quality of service level at the destination node, while taking into account the re-amplifications of the useful signal at each relay and multiple interferences, in particular when all the implemented nodes use the same frequency band.

According to yet another aspect of the disclosure, the overall transmission rate is estimated from the following expression:

$$D {G}_{N} = \cdot \frac{{Vol}_{N}}{{\sum }_{j = 1}^{N} \frac{{Vol}_{j}}{{W}_{j} log 2 ( 1 + \frac{1}{{\prod }_{i = 1}^{j} ( 1 + \frac{1}{{θ}_{j}} ) - 1}} )}$$

where Vol_{N} is the data volume received by the destination node located at N hops from the source node,
Volⱼ is the data volume received by the node ERj,
Wi is the bandwidth available at the node ERi
θᵢ is the strength ratio of a relay node ERi.

In this embodiment, the bandwidth varies from one relay node to another, as does the data volume.

An aspect of the disclosure also relates to a computer program product comprising program code instructions for implementing a method for controlling a multi-hop transmission according to the disclosure, as described previously, when it is executed by a processor.

An aspect of the disclosure also relates to a computer-readable storage medium on which the computer programs as described above are recorded.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to an aspect of the disclosure can be downloaded in particular on a network, for example the Internet network.

Alternatively, the storage medium can be an integrated circuit in which the program is embedded, the circuit being adapted to execute or to be used in the execution of the above-mentioned control method.

An aspect of the disclosure also relates to a device for controlling a multi-hop transmission in a wireless communication network, said transmission implementing a plurality of relay nodes of said wireless communication network, a relay node, referred to as the current relay node of said plurality, located at i hops, with i a non-null integer, being configured to receive from a source node or from a previous relay node located at hop i-1, a radio signal carrying a data volume transmitted by said source node, to amplify it and to retransmit it to a next relay node, placed at i+1 hops.

Said device is configured to implement:
obtaining for said current relay node a current strength ratio between a strength of the radio signal and a noise and interference strength, at said current relay node, received by said current relay node;

estimating an overall transmission rate between the source node and a destination node located at a number of hops N, with N an integer greater than or equal to i, at least from the current strength ratio, from strength measurement ratios previously obtained for relay nodes located between the source node and said current relay node and from a transmission bandwidth;
adjusting at least one data transmission parameter of at least the source node and/or one said relay node participating in the multi-hop transmission, when the estimated overall transmission rate differs from a target rate.

Advantageously, said device is configured to implement the above-mentioned control method, according to its various embodiments.

Advantageously, said device is integrated into a node of the system, for example a relay node or the source node. Alternatively, it can be integrated into another communication node, for example in a cellular network, the base station to which the relay nodes and the source node are attached. Correlatively, an aspect of the disclosure also relates to a method for processing a multi-hop transmission of a radio signal transmitted by a source node in a wireless communication network, said transmission implementing a plurality of relay nodes of said wireless communication network, a relay node located at a certain number of hops i from the source node, with i a non-null integer, being configured to receive said radio signal from said source node or from a previous relay node, of rank i-1, to amplify it and to retransmit it to a next relay node, of rank i+1.

Said method comprises:
transmitting to a control device a strength of the radio signal and a noise and interference strength at the current relay node, received by the current relay node;
receiving from said control device an action message in the wireless communication network comprising an action for adjusting at least one data transmission parameter within the multi-hop transmission; and performing the adjustment action contained in said action message, when it is intended for said current relay node.

With an aspect of the disclosure invention, the relay node transmits strength measurements to a control device that uses them to check that at least one quality of service criterion is met for the multi-hop transmission, sending back to it if necessary an action to be performed to adjust one or more parameters of the communication.

According to another aspect of the disclosure, the action message further comprising at least one number of hops, the method comprises:
extracting the at least one number of hops comprised in said message; and
verifying that the number of hops of the current relay node corresponds to an extracted number of hops.

One advantage is to determine whether the relay node is the target of the action message when it is broadcast in a group comprising several relay nodes.

An aspect of the disclosure also relates to a computer program product comprising program code instructions for implementing a method for transmitting a multi-hop transmission according to the disclosure, as described previously, when it is executed by a processor.

An aspect of the disclosure also relates to a computer-readable storage medium on which the computer programs as described above are recorded.

Such a storage medium can be any entity or device able to store the program. For example, the medium can comprise a storage means, such as a ROM, for example a CD-ROM or a microelectronic circuit ROM, or a magnetic recording means, for example a USB flash drive or a hard drive.

On the other hand, such a storage medium can be a transmissible medium such as an electrical or optical signal, that can be carried via an electrical or optical cable, by radio or by other means, so that the computer program contained therein can be executed remotely. The program according to the disclosure can be downloaded in particular on a network, for example the Internet network.

Alternatively, the storage medium can be an integrated circuit in which the program is embedded, the circuit being adapted to execute or to be used in the execution of the above-mentioned processing method.

The disclosure also relates to a device for processing a multi-hop transmission of a radio signal transmitted by a source node in a wireless communication network, said transmission implementing a plurality of relay nodes of said wireless communication network, a relay node located at a number of hops i from the source node, with i a non-null integer, being configured to receive said radio signal from said source node or from a preceding relay node, of rank i-1, to amplify it and to retransmit it to a next relay node, of rank i+1, characterised in that said device is configured to implement:
transmitting to a control device a strength of the radio signal and a noise and interference strength at the current relay node, received by the current relay node;
receiving from said control device an action message (MA) in the wireless communication network comprising an action for adjusting at least one transmission parameter within the multi-hop transmission;
performing the action contained in said action message, when it is intended for said current relay node.

Advantageously, said device is configured to implement the above-mentioned processing method, according to its various embodiments.

Advantageously, said device is integrated in a relay node of the system.

Correlatively, the disclosure finally relates to a multi-hop transmission system in a wireless communication network, comprising a source node configured to transmit in said network a radio signal and a plurality of relay nodes configured to receive, amplify and retransmit the radio signal transmitted by the source node.

Said system comprises the above-mentioned device for controlling a multi-hop transmission and said relay nodes comprise the above-mentioned device for processing said multi-hop transmission.

### BRIEF DESCRIPTION OF THE FIGURES

Other purposes, features and advantages of aspects of the disclosure will become more apparent upon reading the following description, hereby given to serve as an illustrative and non-restrictive example, in relation to the figures, among which:

FIG. 1: shows an example of the architecture of a multi-hop transmission system implemented in a wireless communication network comprising a source node, a plurality of relay nodes and a device for controlling said transmission, configured to control said plurality of relay nodes according to an aspect of the disclosure;

FIG. 2: diagrammatically illustrates an example of the architecture of the device for controlling a multi-hop transmission implemented in a wireless communication network by said system and of a relay node of said system, integrating a device for processing the multi-hop transmission, according to one embodiment of the disclosure;

FIG. 3: describes in the form of a flowchart the steps of a method for controlling a multi-hop transmission, according to one embodiment of the disclosure;

FIG. 4: describes in the form of a flowchart the steps of a method for processing a multi-hop transmission by a relay node of said plurality, according to one embodiment of the disclosure;

FIG. 5: describes an example of a hardware structure of a device for controlling a multi-hop transmission implemented in a wireless communication network according to the disclosure; and

FIG. 6: describes an example of a hardware structure of a device for processing a multi-hop transmission implemented in a wireless communication network according to the disclosure.

### DETAILED DESCRIPTION OF ILLUSTRATIVE ASPECTS OF THE DISCLOSURE

The principle of an aspect of the disclosure consists in estimating an overall transmission rate of a useful data signal, transmitted by a source node in a wireless communication network implementing a multi-hop transmission via one or more relay nodes, reached at a destination node located at N hops from said source node. This rate estimate is based on first obtaining at least one ratio between a strength of the useful signal received by a relay node of said network placed at i hops, with i less than or equal to N, and an interference strength received at this relay node. If this estimated overall transmission delay does not correspond to a predetermined target transmission rate, an aspect of the disclosure proposes an adjustment of at least one data transmission parameter on at least one communication node participating in the multi-hop transmission. For this purpose, an action message transmitted in the network to this or these communication nodes can for example be drawn upon, indicating to it or them a modification to be applied to at least one data transmission parameter within the multi-hop transmission. The relevant communication nodes may be all or part of the plurality of relay nodes and/or the source node.

The transmission parameters to be modified may, for example, comprise a transmission strength of a data signal by the communication node considered or a transmission bandwidth by this node.

An aspect of the disclosure thus has a particularly interesting application in managing queues of vehicles, at least partially autonomous. In this use case, each vehicle incorporates a mobile terminal node, configured to transmit to the vehicles in proximity information relating to vehicle control commands, for example when changing direction, braking, etc. Of course, the disclosure is not limited to this example of a use case, but could also be applied in other contexts, as for example to a system of interconnected production machines in a factory or, more generally, to any system of connected objects.

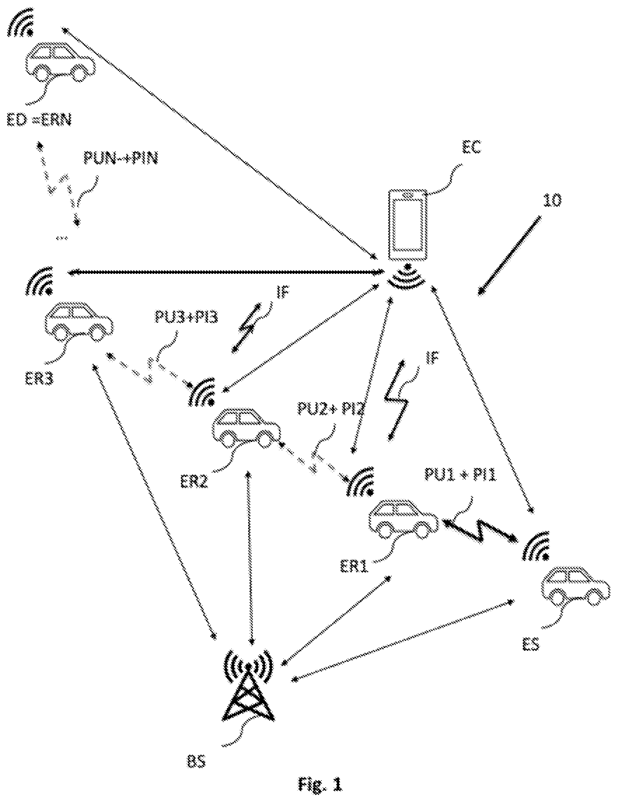

In relation to FIG. 1, an example of the architecture of a system 10 for managing a multi-hop transmission in a wireless communication network, for example cellular radio, implementing a source node ES, for example a first vehicle embedding a mobile communication node and transmitting a radio signal carrying a useful data volume Vol in the network, which is then relayed at least in part by a plurality of relay nodes ER1, ER2 . . . ERN, for example other vehicles each embedding a mobile communication node, is now presented. This data volume is sent to one or more destination nodes, for example the last vehicle ERN or all the relay nodes.

In the remainder of the description, we will focus more specifically on the case of a group of vehicles platooning or a road convoy travelling in a road system that is at least partially automated. In this context, known as V2X (for “vehicle to anything”), the source node (or first communication node) broadcasts data to the group via a “sidelink” or SL communication channel according to the specifications of the 3GPP RAN. For example, the messages broadcast are of the CAM (Cooperative Awareness Message) type.

With this technology, the communication nodes of the same group of vehicles are attached to the same base station and form part of the same broadcast group, that is the messages or data volumes are intended for the same group address. In the example of FIG. 1, the group of vehicles comprises the source node ES, the relay nodes ER1, ER2, ER3 . . . ERN. Thanks to V2X communication, the vehicles in the leading group can accelerate or brake in unison.

The base station transmits to the nodes in the group the frequency time resources to be used to broadcast these messages. It also transmits them other information useful for implementing the multi-hop transmission.

Of course, the disclosure is not limited to this embodiment, but applies to any multi-hop transmission between a source node and a destination node via a plurality of relay nodes. For simplicity, it is assumed here that all the nodes involved are attached to the same base station.

It is also assumed that all the communication nodes involved in the multi-hop transmission use the same frequency band, for example 10 MHZ. Naturally, this value is given by way of illustration only and does not limit the disclosure.

The disclosure also applies to any wireless communication network, non-cellular, such as for example, a Wi-Fi network, managed by a home or professional gateway. In this case, the communication nodes implemented in the multi-hop transmission obtain the information needed to implement this direct communication from the gateway. More generally, it applies to any type of network, such as a satellite network or an adhoc network of connected objects, for example of the LoRa or Sigfox type (registered trademarks).

As illustrated in FIG. 1, the system 10 according to an aspect of the disclosure comprises the source node ES, the plurality of relay nodes ER1-ERN and another communication node EC, configured to control the processing of the multi-hop transmission by the plurality of relay nodes ER1-ERN according to an aspect of the disclosure. This is, for example, the base station BS, the source node ES, one of the relay nodes of the plurality or even another communication node EC also attached for example to the base station BS.

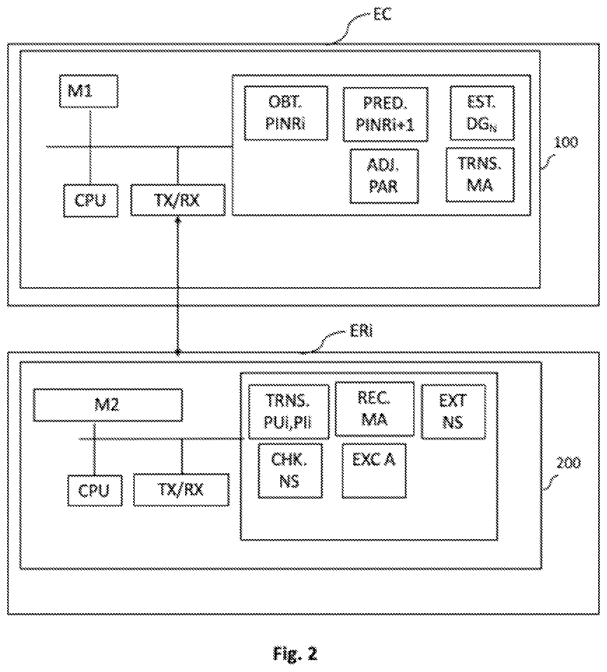

FIG. 2 shows an example of the architecture of the communication node EC according to one embodiment of the disclosure. According to this example, the communication node EC comprises a device 100 for controlling the plurality of relay nodes ER1-ERN according to the disclosure. This device comprises at least one module OBT. PINRi for obtaining a current strength ratio from strengths measured and received from at least one relay node ERi, referred to as a current relay, of said plurality, placed at i hops from the source node, with i non-null. By convention, it is considered in the following that the radio signal transmitted by the source node is relayed in the order of the indices of the relay nodes ERi. These strengths measurements comprise a strength measurement Pui of the radio signal received by said relay node ERi and a strength measurement of noise and interference Pli received at the current relay node ERi. The device 100 also comprises a module EST. DGN for estimating an overall transmission rate of said radio signal transmitted by the source node to a destination node placed at N hops, with N an integer greater than or equal to i, at least from the current strength ratio and from strength ratios obtained for previous relay nodes, and a module MOD. CNF for adjusting at least one data transmission parameter, configured to be implemented when the estimated overall transmission rate differs from an expected or desired target transmission rate.

The radio signal transmitted by the source node carries a useful data volume Vol. The relay nodes ER1-ERN can relay all or part of this volume. In the following, the case of a constant volume Vol will be distinguished from a useful data volume that changes throughout the multi-hop transmission with the successive relays.

Advantageously, the device comprises a module PRED PINRi+1 for predicting strength ratios of relay nodes located at hop numbers higher than the one of the current relay node and a module TRNS. MA for transmitting an action message comprising an action for adjusting said at least one transmission parameter.

Alternatively, the device 100 may be independent of the communication node EC, but connected to it by any link whatsoever, wired or not.

Advantageously, the device 100 comprises at least one module TX/RX for transmitting and receiving signals in the communication network and a module M1 for storing data. Alternatively, it uses the transmission/reception module and/or the storage module of the communication node into which it is integrated.

The non-volatile memory M1 advantageously comprises the strength ratios obtained for the relay nodes involved in the multi-hop transmission.

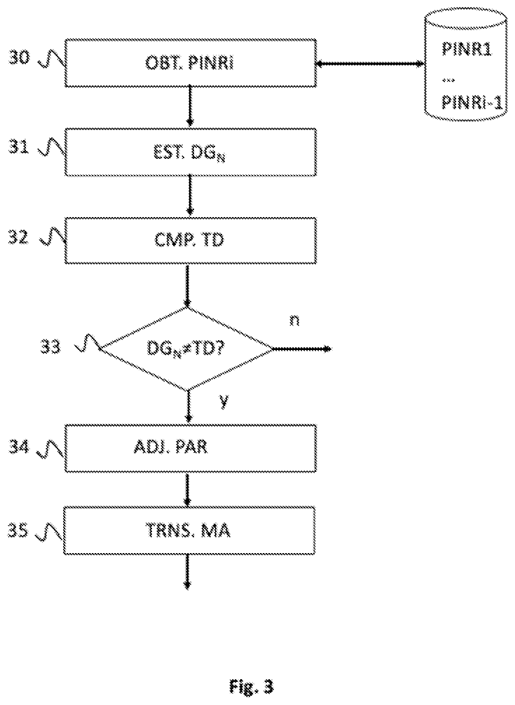

The device 100 thus implements the method for controlling a multi-hop transmission implemented by a plurality of relay nodes within a wireless communication network according to the disclosure that will be detailed hereafter in relation to FIG. 3.

FIG. 2 also shows an example of the architecture of a relay node ERi according to one embodiment of the disclosure. According to this example, the relay node ERi comprises a device 200 for processing a multi-hop transmission in which a radio signal carrying a data volume is transmitted by a source node and received from this source node or from a previous relay node by said relay node ERi. The device 200 comprises a module TRNS PUi, Pli, for transmitting a strength of the radio signal and a strength of the interference and noise at this relay node, received and measured by the relay node ERi, to a control device 100 as described previously, and a module REC. MA for receiving an action message comprising an action for adjusting at least one data transmission parameter from the control device 100 just described.

Advantageously, the device 200 also comprises a module EXT. NS for extracting at least one number of hops comprised in said action message and a module CHK. NS for verifying that the adjustment action is intended for it, based on the number of hops extracted.

Alternatively, the device 200 may be independent of the relay node ERi, but connected to it by any link whatsoever, wired or not.

Advantageously, the device 200 also comprises a module TX/RX for receiving, amplifying and transmitting information in the wireless communication network and a module M2 for storing data, for example a non-volatile memory.

The non-volatile memory M2 advantageously comprises the strength measurements, the adjustment action and the number(s) of hops NS received in the action message.

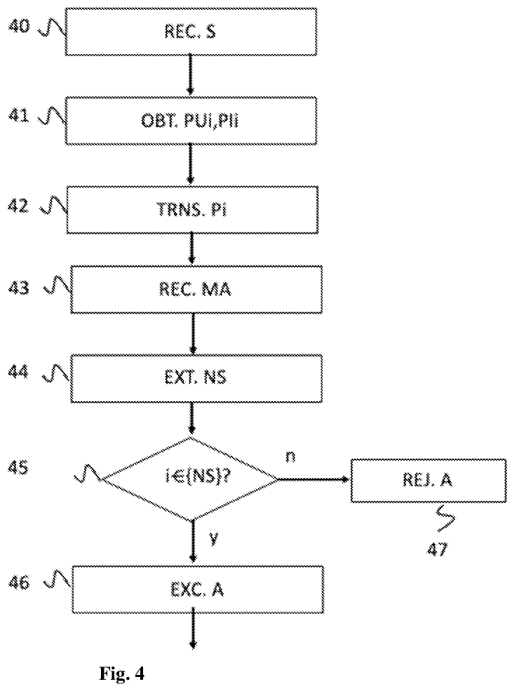

The device 200 thus implements the method for processing a data signal according to the disclosure that will be detailed hereafter in relation to FIG. 4.

In relation to FIG. 3, an embodiment of a method for controlling a multi-hop transmission in the wireless communication network of FIG. 1 is now presented in the form of a flowchart. It is assumed that the source node ES has transmitted a radio signal carrying a useful data volume Vol to at least one destination node ED. The signal is first received by a first relay node ER1, which amplifies it and retransmits all or part of the data of the data volume in the network, possibly completed by other data added by the relay node. The retransmitted radio signal is received by a second relay node ER2, that proceeds in a similar way to what was just described for the relay node ER1, and so on, until the destination node ED. It is assumed here that the destination node ED is located at N hops, with N an integer greater than or equal to 2, in other words, ED=ERN according to the notations introduced earlier. In addition, for the sake of simplicity in the remainder of the description, it is assumed that the same useful data volume Vol is transmitted from the source node ES to the destination node ED and relayed by each of the relay nodes involved in the multi-hop transmission. However, the disclosure also applies when all or only part of the data volume Vol transmitted by the source node ES is relayed, possibly completed by other data added by one or more relay nodes involved in the multi-hop transmission. The control method according to an aspect of the disclosure that will now be described is implemented, for example, by the control device 100 integrated into the communication node EC. A current relay node ERi that just received the radio signal carrying the data volume Vol from a previous relay node ERi-1 is considered in particular. It is assumed that this relay node ERi as well as all the other communication nodes (other relay nodes, source node and destination node) used in the multi-hop transmission have previously been informed by the base station BS of the address of the control device 100. Alternatively, the communication nodes participating in the multi-hop transmission transmit information to the base station BS, that retransmits it to the control device whose network address it knows.

In 30, a strength measurement PUi of the radio signal received by the current relay node ERi and a strength measurement Pli of the interference and noise at this relay node ERi are received by the control device 100 for example via common channels or traffic channels. According to a first option, they have been transmitted by the relay node ERi to the control device 100 according to a multi-hop transmission mode, or they have been sent by the relay node ERi to the base station BS for retransmission to the control device 100.

A ratio between these two strengths PINRi=PUi/Pli is calculated. Alternatively, the ratio PINRi in question is received directly from the relay node ERi.

In 31, the current strength ratio PINRi is used to estimate an overall transmission rate DGN of the data volume from the source node ES to the destination node located at N hops from the source node. This estimate is also a function of the bandwidth available for the multi-hop transmission and the strength ratios PINR1 to PINRi-1 obtained for the previous hops between the source node ES and the current relay node ERi. For example, these strength ratios PINR1-PINRN are stored in memory.

According to a first embodiment, it is assumed that the bandwidth W is the same at the source node ES and at each of the relay nodes ER1 to ERN.

Advantageously, the overall transmission rate DG_{N} is then estimated from the following expression:

$${DG}_{N} = W \cdot \frac{1}{{\sum }_{j = 1}^{N} \frac{1}{log 2 ( 1 + \frac{1}{{\prod }_{i = 1}^{j} ( 1 + \frac{1}{{θ}_{j}} ) - 1}} )} \qquad ( 1 )$$

Where W is the bandwidth available for the multi-hop transmission between the source node and the destination relay node located at N hops and at each relay node ERi, and θᵢ corresponds to the strength ratio PNRi at the relay node ERi. θᵢ represents more precisely the ratio between:
the strength PUi received by the relay ERi from the relay ERi-1, and
the total interfering strength Pli received by the relay ERi from other entities of the system 10 to which thermal noise is added.

It is also expressed as follows:

$${θ}_{i} = \frac{P {e}_{i - 1} {g}_{i - 1}}{{P}_{o t h} + N t h} = \frac{{Q}_{i}}{{P}_{o t h} + N t h} \qquad ( 2 )$$

Where:
Peᵢ₋₁ is the transmission strength of the relay Ri-1 (or the source node ES if i=1)
gᵢ₋₁ is the gain due to the propagation between the relay ERi and the relay ERi-1 (or the source node ES and the first relay if i =1);
Qᵢ=Peᵢ₋₁ gᵢ₋₁ is the strength received by the relay ERi from the relay ERi-1 (or the source node ES and the first relay if i=1)
Pₒₜₕₑᵣ+Nₜₕ is the total interfering strength received by the relay i from the other entities of the system (including the base stations of the network), to which thermal noise is added, and
Peᵢ₋₁gᵢ₋₁+Pₒₜₕₑᵣ+Nₜₕ is the total strength received by the relay ERi.

At this stage, several cases are considered.

It is recalled that it is assumed here that the data volume Vol is transmitted as it is by the system 10 and that the bandwidth W is constant throughout the multi-hop transmission.

According to a first option, the case where N is equal to i is considered. In other words, the current relay node ERi is the destination relay node located at N hops. This is an “on-the-fly” embodiment, according to which the transmission rate is estimated as the data volume is retransmitted by the successive relay nodes within the multi-hop transmission.

The control device has therefore already received the strength ratios PINRi=0; from all the relay nodes that relayed the radio signal carrying the data volume Vol to the destination relay node located at N hops.

According to a second option, N is strictly greater than i. This is an anticipatory control mode. The control device 100 has therefore not yet received any strength measurements from the relay nodes ERi+1 to ERN. It cannot therefore calculate the strength ratios PINRI+1 to PINRN it needs to estimate the overall transmission delay DG_{N}, as shown in equation 1.

Advantageously, according to this second option, an aspect of the disclosure implements a prediction of these strength ratios that are not yet available. For example, they are predicted from the strength ratio obtained for the current relay node ERi, for example by considering that θ_{N}=θ_{N-1}= . . . =θᵢ₊₁=θᵢ. It should be noted that this assumption is absolutely realistic. Indeed, an initial configuration of communication nodes, such as mobile terminals, may be to apply an amplification such that this assumption is correct.

As a variant, an average of the strength ratios obtained for the current and previous relay nodes is calculated and used to predict θᵢ₊₁ at θ_{N}.

According to a second embodiment, it is assumed that the data volume Vol is transmitted as it is, but that the bandwidth Wi varies according to the communication nodes involved in the multi-hop transmission. In this case, the overall transmission rate at the relay node located at N hops is estimated as follows:

$${DG}_{N} = \frac{1}{{\sum }_{j = 1}^{N} \frac{1}{{W}_{j} log 2 ( 1 + \frac{1}{{\prod }_{i = 1}^{j} ( 1 + \frac{1}{{θ}_{i}} ) - 1}} )} \qquad ( 3 )$$

Thus, the overall transmission rate DGN at the relay node located at N hops depends on the available Wi bandwidth and the strength ratios θᵢ at each relay ERi.

It is understood that according to this second example, the control device 100 needs to know the bandwidth Wi specific to each relay node ERi. For example, it is received from the relay node ERi in 30. According to a third embodiment, the more general case of a relay node ERi that does not necessarily retransmit the volume Vol as it is, but a volume Voli derived from the volume Vol (for example a volume Voli consisting of all or part of the volume Vol, or all or part of this volume Vol completed by other data) and that of an available bandwidth that varies from one relay node to another (for example, Wi at the relay node ERi) are now considered, the equation (1) becomes:

$$D {G}_{N} = \cdot \frac{{Vol}_{N}}{{\sum }_{j = 1}^{N} \frac{{Vol}_{j}}{{W}_{j} log 2 ( 1 + \frac{1}{{\prod }_{i = 1}^{j} ( 1 + \frac{1}{{θ}_{j}} ) - 1}} )} \qquad ( 1 bis )$$

where Volj is the data volume received by the relay node ERj and Vol1 is the data volume Vol transmitted by the source node,

VoIN the data volume received by the destination node located at N hops from the source node. It should be noted that assuming that the data volume Vol, Voli changes during the multi-hop transmission, the device 100 also receives from the relay node ERi, with i greater than or equal to 2, an item of information relating to the data volume Voli received from the previous relay node. Similarly, if the bandwidth Wi varies with the relay node ERi, the device 100 receives from the relay node ERi an item of information relating to its bandwidth Wi.

In 32, the estimated overall transmission rate is compared with a target rate TD, expected at the destination node. For example, this target data rate, predetermined to meet quality of service constraints, has been transmitted to each relay node ER1-ERN by the base station BS. This target rate may or may not depend on a number of hops separating the considered relay node from the source node ES. For simplicity, a single target rate value TD is considered in the following, for example in the order of 1 Mbit/s.

In 33, the result of the comparison is reviewed. If the estimated overall rate matches the target rate to within a margin of error, no adjustment of the transmission parameters is decided. On the contrary, if the estimated overall rate does not correspond to the target rate, the adjustment of at least one transmission parameter is decided for at least one communication node participating in the current transmission, that is the source node and/or one or more relay nodes ERi.

As for the transmission parameter(s), these are parameters that have an impact on this overall transmission rate DG_{N}, such as the transmission strengths of the radio signal and/or the transmission bandwidth W,Wi or yet the angular antenna gain at one or more participating communication nodes. Indeed, the transmission strength of the radio signal carrying the data volume by the source node and/or a relay node will have an impact on the reception strength of this radio signal by the next relay node. The same is true for the bandwidth Wi.

According to a first option, the decided modification action concerns the transmission strength Pe at at least one participating communication node.

If the estimated overall transmission rate is less than the target rate, the decision is to increase the transmission strength Pe of at least one of these communication nodes by a predetermined increment value PInc. For example, for radio transmission strengths in the order of 40 W, i.e. 46 dBm, an increment value Plnc=1mW is chosen, that is O dBm.

On the contrary, if the overall transmission rate DGN is higher than the target rate TD, the decision is to decrease the transmission strength by this increment value.

According to a second option, the transmission parameter concerned by the modification is the bandwidth Wi. Similarly, if the estimated overall transmission rate is less than the target rate, the decision is to increase the transmission bandwidth Wi of at least one of these communication nodes by a predetermined increment value WInc. For example, for transmission bandwidths Wi in the order of 10 MHz, the increment value WInc is chosen to be equal to 1 MHz. On the contrary, if the overall transmission rate DGN is higher than the target rate TD, the decision is to decrease the transmission bandwidth by the same increment value.

In this case, it is assumed that the control device stores in memory the modified value of the bandwidth for each of the communication nodes concerned. In this way, it will have the new bandwidth value for these nodes at the time of its next global transmission rate estimate. Alternatively, it obtains the current value of the bandwidth W, Wi of the current relay node in 30, at the same time as the strength measurements Pi and PIB.

According to a third option, the decided modification concerns both the transmission strength Pej and the bandwidth Wi of the source node or of one or more relay nodes ERi.

For example, in the case where the estimated overall rate is less than the target rate, it may be chosen to increase the transmission strength and/or the bandwidth of the relay node that has the lowest strength ratio PINRi among the relay nodes participating in the transmission, which will increase the overall rate of the transmission at the node located at N hops.

In 34, an action message MA comprising the action decided in 33 is transmitted to one or more communication nodes involved in the current communication.

Several cases are considered:

According to a first strategy, the destination communication node of the action message MA is the source node ES. The result is that the impact of the requested modification will only be felt when the next data volume Vol′ is transmitted within the same multi-hop transmission.

According to a second strategy, the destination communication nodes of the action message MA are one or more relay nodes. In the case where N was chosen to be equal to i, that is in an on-the-fly control strategy, the control device knows the strength ratios PINRi and possibly the transmission bandwidths Wi of all the relay nodes implemented in retransmitting the data volume to the relay N. It can therefore decide to modify one or more of their transmission parameters with a view to transmitting a next data volume Vol′. Indeed, knowing the strength ratios PINRi of each of the relay nodes participating in the transmission, the control device can determine the impact on the overall transmission rate of each of the corresponding relays and modify their transmission strength and/or their bandwidth in order to achieve the target rate at the destination node.

Of course, the first and second strategies can be combined for a greater impact action. In the case where N is strictly greater than i, that is in an anticipatory control strategy, the control device 100 only knows the strength ratios of the relay node ERi and the previous relay nodes E1-ERi-1. To estimate the overall transmission rate DG_{N} at N hops, it has predicted in 31 the strength ratios of the next relay nodes that have not yet sent it any strength measurements.

Several options are then considered:
according to a first option, the action message is sent to the current ERi and previous relay nodes ER1-ERi-1 and possibly the source node ES, so that the modification impacts the transmission rate of a next data volume Vol′.

According to a second option, the action message is sent to the following relay nodes ERi+1 à ERN-1, in order to take rapid action on the current transmission of the data volume Vol. However, for these next nodes, the control device relies at best on strength ratios and/or bandwidth values obtained for a previous transmission and stored in memory for these communication nodes or even on assumptions similar to those made to predict these strength ratios in 31.

The action message MA is transmitted to the destination nodes either using a direct, multi-hop transmission mode or via the base station BS.

In the embodiment according to which a group address is used, the action message MA is broadcast to the group address. In this case, the action message specifies, in addition to the action to be performed, the hop number(s) of the relay nodes concerned. For the source node, the hop number is for example chosen to be equal to zero.

In relation to FIG. 4, an embodiment of a method for processing a multi-hop transmission in a wireless communication network, said transmission implementing a plurality of relay nodes of said wireless communication network is now presented.

Advantageously, the method is implemented by the processing device 200 of FIG. 2, which is integrated within a relay node ERi configured to receive from a source node ES or from a previous relay node located at hop i-1, a radio signal carrying a data volume transmitted by said source node ES, amplify it and retransmit it to a next relay node, paced at i+1 hops.

In 40, the device 200 obtains at least one strength measurement Pi of the radio signal received by the relay node ERi and a strength measurement PIBi of noise and interference received at the current relay node ERi.

In 41, it transmits at least these measurements to the control device 100. As previously mentioned, it is assumed that it knows a network address of this device 100 or of the communication node EC in which it is integrated, for example because it has received it from the base station BS to which it is attached. As a variant, it transmits these measurements to the base station BS, which retransmits them to the control device 100.

According to another embodiment, the relay node ERi also transmits a transmission bandwidth value Wi. As previously mentioned in relation to FIG. 3, this information is in fact necessary for the control device 100 according to an aspect of the disclosure, when the various relay nodes ERi and possibly the source node use distinct bandwidths.

In 43, the processing device 200 receives from the control device 100 an action message MA comprising at least one action for adjusting at least one data transmission parameter within the multi-hop transmission.

According to a first option, the at least one parameter to be adjusted comprises a transmission strength Pe at the relay node ERi.

The adjustment may consist in increasing or decreasing this transmission strength Pe. Advantageously, the instruction comprises a predetermined increment or decrement value PInc. As a variant, the increment or decrement value is predetermined and known in advance to the relay node ERi. In this case, the action only indicates whether it is an increment or a decrement.

According to a second option, the adjustment relates to the bandwidth W, Wi of the relay node ERi and may consist in an increase or a decrease, for example by a predetermined or non-predetermined increment or decrement value.

Of course, the action can combine the two previous options.

According to an embodiment of the disclosure, the action message MA is addressed to a group of communication nodes attached to the base station BS. In this case, the relay node ERi has to determine whether the message AM it has received as a member of the group is specifically intended for it or not. To do this, it is assumed that the action message also comprises an item of information about the number of hops of the relay nodes of the group concerned by the action to be performed. The method then implements in 44 an extraction of the number or numbers of hops comprised in the message MA and checks them in 45 if they correspond to its current number of hops i. If there is no match, it decides in 47 not to perform the action.

If one of the extracted numbers corresponds to its current number of hops, it performs in 46 the action requested by the control device 100, updating its configuration.

Advantageously, it stores in memory the adjusted value of the transmission parameter(s).

As a variant, a specific action message is sent to each communication node participating in the multi-hop transmission for which a transmission parameter adjustment has been decided.

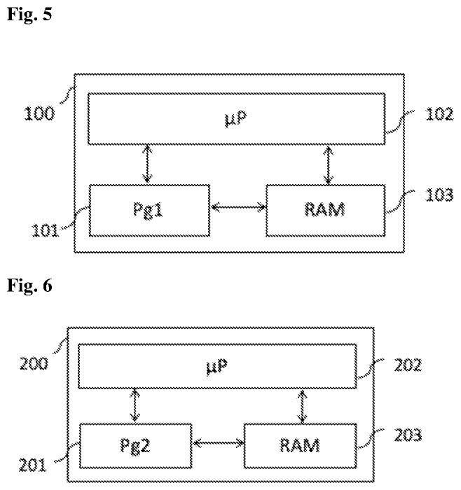

In relation to FIG. 5, another example of the hardware structure of a device 100 for controlling a multi-hop transmission in a wireless communication network according to the disclosure, comprising, as illustrated in FIG. 2, at least one obtaining module, one estimation module and one adjustment module, is now presented.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 100 comprises a random access memory 103 (a RAM memory, for example), a processing unit 102 equipped for example with a processor and controlled by a computer program Pg1, representative of the obtaining, transmission and adjustment modules, stored in a read-only memory 101 (a ROM memory or hard disk, for example). At initialisation, the code instructions of the computer program are for example loaded into a random access memory 103 before being executed by the processor of the processing unit 102. The random access memory 103 can also comprise the strength ratios obtained from previous relay nodes, where applicable their bandwidth values W, Wi and the previously estimated transmission rates.

FIG. 5 only shows a particular one of several possible ways of realising the device 100, so that it executes the steps of the method for controlling a multi-hop transmission in a wireless communication network as detailed above, in relation to FIG. 3 in its various embodiments. Indeed, these steps may be implemented either on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 100 is realised with a reprogrammable computing machine, the corresponding program (i.e. the sequence of instructions) can be stored in a removable (such as, for example, an SD card, a USB flash drive, CD-ROM or DVD-ROM) or non-removable storage medium, this storage medium being partially or totally readable by a computer or a processor.

The various embodiments have been described above in relation to a device 100 integrated into a communication node of the network, for example the source node ES, the base station BS, one of the relay nodes ERi or yet another communication node EC for example attached to the same base station. Of course, the device 100 may also be independent of the communication node in question and connected to it by any link whatsoever.

In relation to FIG. 6, another example of the hardware structure of a device 200 for processing a multi-hop transmission in a wireless communication network according to the disclosure, comprising, as illustrated by the example in FIG. 2, at least one module for transmitting strengths measured by a relay node of said network and one module for receiving an action message comprising an action for adjusting at least one transmission parameter is also presented.

Advantageously, the device further comprises a module for extracting at least one number of hops received in said message at a hop number of said relay node, a module for verifying that the action is intended for it and a module for performing the action configured to perform or not perform the action depending on the result of the verification.

The term “module” can correspond to a software component as well as to a hardware component or a set of hardware and software components, a software component itself corresponding to one or more computer programs or sub-programs, or more generally, to any element of a program capable of implementing a function or set of functions.

More generally, such a device 200 comprises a random access memory 203 (a RAM memory, for example), a processing unit 202 equipped for example with a processor and controlled by a computer program Pg2, representative of the transmission, reception and execution modules, stored in a read-only memory 201 (a ROM memory or hard disk, for example). At initialisation, the code instructions of the computer program are for example loaded into a random access memory 203 before being executed by the processor of the processing unit 202.

FIG. 6 only shows a particular one of several possible ways of realising the device 200, so that it executes the steps of the method for processing a multi-hop transmission as detailed above, in relation to FIG. 4 in its various embodiments. Indeed, these steps may be implemented either on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the device 200 is realised with a reprogrammable computing machine, the corresponding program (i.e. the sequence of instructions) can be stored in a removable (such as, for example, an SD card, a USB flash drive, CD-ROM or DVD-ROM) or non-removable storage medium, this storage medium being partially or totally readable by a computer or a processor.

The various embodiments have been described above in relation to a device 200 integrated into a relay node ERi. Of course, the device 200 may also be independent of the relay node ERi in question and connected to it by any link whatsoever.

The disclosure that has just been described in its different embodiments has many advantages. Generally speaking, it applies to a group of objects connected in a wireless communication network, such as a line of vehicles, which transmit information from one to the next in a direct, multi-hop communication mode, or machines on the same production line.

An aspect of the disclosure indeed estimates an overall transmission rate of the data transmitted by the first connected object to a last connected object without the need for a calculation from one to the next, and uses this estimate to control and guarantee a predetermined quality of service level between the connected objects, whatever the number of relays involved in the multi-hop transmission.

An aspect of the disclosure improves the situation with respect to the prior art.

In particular, an aspect meets the need to guarantee that a predetermined quality of service level is achieved.

An aspect also meets the need for simple control of the performance of a multi-hop transmission system in terms of quality of service.

Although the present disclosure has been described with reference to one or more examples, workers skilled in the art will recognize that changes may be made in form and detail without departing from the scope of the disclosure and/or the appended claims.

1. A control method comprising:
controlling a multi-hop transmission in a wireless communication network, said transmission implementing a plurality of relay nodes of said wireless communication network, a relay node, referred to as a current relay node of said plurality, located at i hops, with i a non-null integer, being configured to receive from a source node or from a previous relay node located at hop i-1, a radio signal carrying a data volume transmitted by said source node, to amplify the radio signal and to retransmit the radio signal to a next relay node, placed at i+1 hops, wherein the controlling is implemented by a control device and comprises:
obtaining for said current relay node a current strength ratio between a strength of the radio signal and a noise and interference strength, at said current relay node, received and measured by said current relay node;
estimating an overall transmission rate between the source node and a destination node located at a number of hops N, with N an integer greater than or equal to i, at least from the current strength ratio, from strength measurement ratios previously obtained for relay nodes located between the source node and said current relay node and from a transmission bandwidth; and
adjusting at least one data transmission parameter of at least the source node and/or one said relay node participating in the multi-hop transmission, in response to the estimated overall transmission rate differing from a target rate.

2. The control method according to claim 1, wherein, when the number of hops N at which is located the node is greater than i, the method comprises a prediction of the strength ratios of the relay nodes located between i+1 and N hops and the estimate of the overall transmission rate at the destination node takes into account the predicted strength ratios.

3. The control method according to, claim 1, wherein the overall transmission rate is estimated from the following expression:
$$D {G}_{N} = W \cdot \frac{1}{{\sum }_{i = 1}^{N} \frac{1}{{log}_{2} ( 1 + \frac{1}{{\prod }_{j = 1}^{i} ( 1 + \frac{1}{{θ}_{j}} )}}}$$
where W designates a transmission bandwidth between the source node and the destination node; and θⱼ is the strength ratio of a relay node ERj preceding the current relay node ERi.

4. The control method according to claim 1, wherein the overall transmission rate (DGN) is estimated from the following expression:
$$D {G}_{N} = \cdot \frac{V o {l}_{N}}{{\sum }_{j = 1}^{N} \frac{{Vol}_{j}}{{W}_{j} log 2 ( 1 + \frac{1}{{Π}_{t = 1}^{j} ( 1 + \frac{1}{{θ}_{j}} ) - 1}} )}$$
where Vol_{N} is the data volume received by the destination node located at N hops from the source node,
Volj is the data volume received by the node ERj,
Wi is the bandwidth available at the node ERi, and
θᵢ is the strength ratio of a relay node ERi.

5. A method comprising:
processing a multi-hop transmission of a radio signal transmitted by a source node in a wireless communication network, said transmission implementing a plurality of relay nodes of said wireless communication network, a relay node located at a number of hops i from the source node, with i a non-null integer, being configured to receive said radio signal from said source node or from a previous relay node, of rank i-1, to amplify the radio signal and to retransmit the radio signal to a next relay node, of rank i+1, wherein the processing is performed by a current relay node of the plurality of relay nodes and comprises:
transmitting (42)-to a control device (100) a strength of the radio signal and a noise and interference strength at the current relay node, received by the current relay node;
receiving from said control device an action message in the wireless communication network comprising an action for adjusting at least one data transmission parameter within the multi-hop transmission and at least one number of hops;
verifying that the adjustment action is intended for said current relay node, comprising verifying that the number of hops of the current relay node corresponds to at least one said number of hops comprised in said action message; and
performing the adjustment action contained in said action message, when the adjustment action is intended for said current relay node.

6. A non-transitory computer readable medium comprising instructions stored thereon which when executed by a processor of a control device configure the control device to implement the method according claim 1.

7. A control device Device for controlling a multi-hop transmission in a wireless communication network, said transmission implementing a plurality of relay nodes of said wireless communication network, a relay node, referred to as a current relay node of said plurality, located at i hops, with i a non-null integer, being configured to receive from a source node or from a previous relay node located at hop i-1, a radio signal carrying a data volume transmitted by said source node, to amplify the radio signal and to retransmit the radio signal to a next relay node, placed at i+1 hops, wherein said control comprises:
at least one processor; and
at least one non-transitory computer readable medium comprising instructions stored thereon which when executed by the at least one processor configure the at least one processor to:
obtain for a current relay node of the plurality of relay nodes a current strength ratio between a strength of the radio signal and a noise and interference strength received and measured by said current relay node;
estimate an overall transmission rate between the source node and a destination node located at a number of hops N, with N an integer greater than or equal to i, at least from the current strength ratio, from strength measurement ratios previously obtained for relay nodes located between the source node and said current relay node and from a transmission bandwidth; and
adjust at least one data transmission parameter of at least the source node and/or one said relay node participating in the multi-hop transmission, in response to the estimated overall transmission rate differing from a target rate.

8. A processing device for processing a multi-hop transmission of a radio signal transmitted by a source node in a wireless communication network, said transmission implementing a plurality of relay nodes of said wireless communication network, a relay node located at a certain number of hops i from the source node, with i a non-null integer, being configured to receive said radio signal from said source node or from a previous relay node, of rank i-1, to amplify it the radio signal and to retransmit it the radio signal to a next relay node, of rank i+1, wherein said processing device is implemented in a current relay node of the plurality of relay nodes and comprises:
at least one processor; and
at least one non-transitory computer readable medium comprising instructions stored thereon which when executed by the at least one processor configure the at least one processor to:
transmit to a control device a strength of a radio signal and a noise and interference strength at the current relay node, received and measured by the current relay node;
receive from said control device an action message in the wireless communication network comprising an action for adjusting at least one transmission parameter within the multi-hop transmission and at least one number of hops;
verify that the adjustment action is intended for said current relay node, comprising verifying that the number of hops of the current relay node corresponds to at least one said number of hops comprised in said action message; and
perform the action contained in said action message, when the action is intended for said current relay node.

9. (canceled)

10. The control method according to claim 1, wherein the control device is integrated into the source node.

11. The control method according to claim 2, characterised in wherein the control device is integrated into a relay node of said plurality of relay nodes.

12. The non-transitory computer readable medium according to claim 6, wherein the control device is integrated into the source node.

13. The non-transitory computer readable medium according to claim 2, wherein the control device is integrated into a relay node of said plurality of relay nodes.

14. The control device according to claim 7, wherein the control device is integrated into the source node.

15. The control device according to claim 7, wherein the control device is integrated into a relay node of said plurality of relay nodes.
